(19) United States
(12) Patent Application Publication
(10) Pub. No.: US 2013/0222701 A1
(43) Pub. Date: Aug. 29, 2013

(54) SYSTEM WITH FUNCTION OF SWITCHING CHANNELS AND METHOD THEREOF

(71) Applicant: Qiang YOU, Shenzhen City (CN)

(72) Inventor: Qiang YOU, Shenzhen City (CN)

(73) Assignees: HON HAI PRECISION INDUSTRY CO., LTD., Tu-Cheng (TW); Fu Tai Hua Industry (Shenzhen) Co., Ltd., ShenZhen City (CN)

(21) Appl. No.: 13/427,913

(22) Filed: Mar. 23, 2012

(30) Foreign Application Priority Data
Feb. 28, 2012 (CN) 201210047008.4

(51) Int. Cl. H04N 5/50

(52) U.S. Cl. 348/731; 348/E05.097

(57) ABSTRACT

A system with a function of switching channels of a television (TV) is provided. The system includes a processing unit and a plurality of modules to be executed by the processing unit. The plurality of modules include a collecting module, a comparing module, and a channel switching module. The collecting module collects a voice frequency of a channel being watched by user at a sampling period. The comparing module compares the voice frequency at a prior sampling period with the voice frequency at a current sampling period. The channel switching module switches the channel being watched to another channel when the voice frequency at the prior sampling period is lower than the voice frequency at the current sampling period.

### BACKGROUND

1. Technical Field

The present disclosure relates to a system with a function of switching channels and a method for switching channels.

2. Description of Related Art

When watching a TV program, the viewer's watching experience may be affected by those advertisement (ad) breaks during the program. It would be desirable that the TV set can automatically switch to another favorite channel during a commercial break.

### BRIEF DESCRIPTION OF THE DRAWINGS

FIG. 1 is a block diagram of the hardware infrastructure of a system with a function of switching channels, in accordance with an exemplary embodiment.

FIG. 2 is a flowchart of a method for switching channels implemented by the system of FIG. 1, in accordance with an exemplary embodiment.

### DETAILED DESCRIPTION

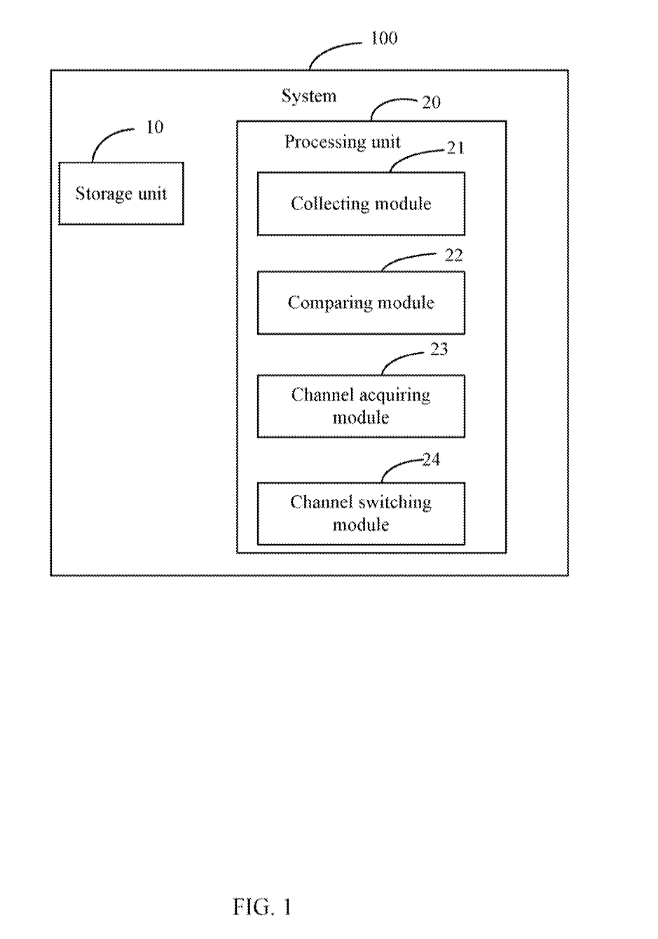

FIG. 1 shows a system 100 with a function of switching channels of a television (TV). The system 100 includes a processing unit 20 and a plurality of modules to be executed by the processing unit 20. The plurality of modules include a collecting module 21, a comparing module 22, and a channel switching module 24.

The collecting module 21 collects a voice frequency of a watching channel at a sampling period. The comparing module 22 compares the voice frequency at a prior sampling period with the voice frequency at a current sampling period. The channel switching module 24 switches the watching channel to another channel when the voice frequency at the prior sampling period is lower than the voice frequency at the current sampling period. In one embodiment, another channel switched from the watching channel is a predetermined channel or a random channel.

In another embodiment, the system 100 further includes a storage unit 10 which stores a number of user's favorite channels. The plurality of modules further include a channel acquiring module 23 to be executed by the processing unit 20.

The channel acquiring module 23 acquires the number of user's favorite channels from the storage unit 10 when the voice frequency at the prior sampling period is lower than the voice frequency at the current sampling period. The channel switching module 24 switches the watching channel to another channel in response to a user operation. For example, when the user watches a channel 1 which plays a teleplay, and suddenly an advertisement (ad) is inserted to play on the channel 1, the channel acquiring module 23 will acquire the number of user's favorite channels, such as a channel 2, a channel 3, etc. The channel switching module 24 will switch the watching channel 1 to one of the number of user's favorite channels such as channel 2 in response to the user operation.

In one embodiment, the channel switching module 24 further switches the watching channel back to the previous watching channel when the voice frequency at the prior sampling period is higher than the voice frequency at the current sampling period. For example, when the ad played on the channel 1 is over, the collecting module 21 collects the voice frequency of the watching channel at the sampling period, the comparing module 22 compares that the voice frequency at the prior sampling period is higher than the voice frequency at the current sampling period, the channel switching module 24 will switch the channel 2 back to channel 1 for the user to watch the teleplay on the channel 1.

In one embodiment, the channel switching module 24 keeps the watching channel unchanged when the voice frequency at the prior sampling period is equal to the voice frequency at the current sampling period. For example, when the teleplay is continually played on the channel 1, the voice frequency at the prior sampling period will equal to the voice frequency at the current sampling period, the channel switching module 24 will keep the watching channel unchanged.

Furthermore, the collecting module 21 collects volume value of the watching channel at a sampling period. The comparing module 22 compares the volume value at a prior sampling period with the volume value at a current sampling period. The channel acquiring module 23 acquires the number of user's favorite channels from the storage unit 10 when the voice frequency at the prior sampling period is lower than the voice frequency at the current sampling period and the volume value at the prior sampling period is less than the volume value at the current sampling period. The channel switching module 24 switches the watching channel to one of the user's favorite channels in response to the user operation. In general, the volume value of the ad is more than that of the teleplay.

The channel switching module 24 switches the watching channel back to the previous watching channel when the voice frequency at the prior sampling period is higher than the voice frequency at the current sampling period and the volume value at the prior sampling period is more than the volume value at the current sampling period.

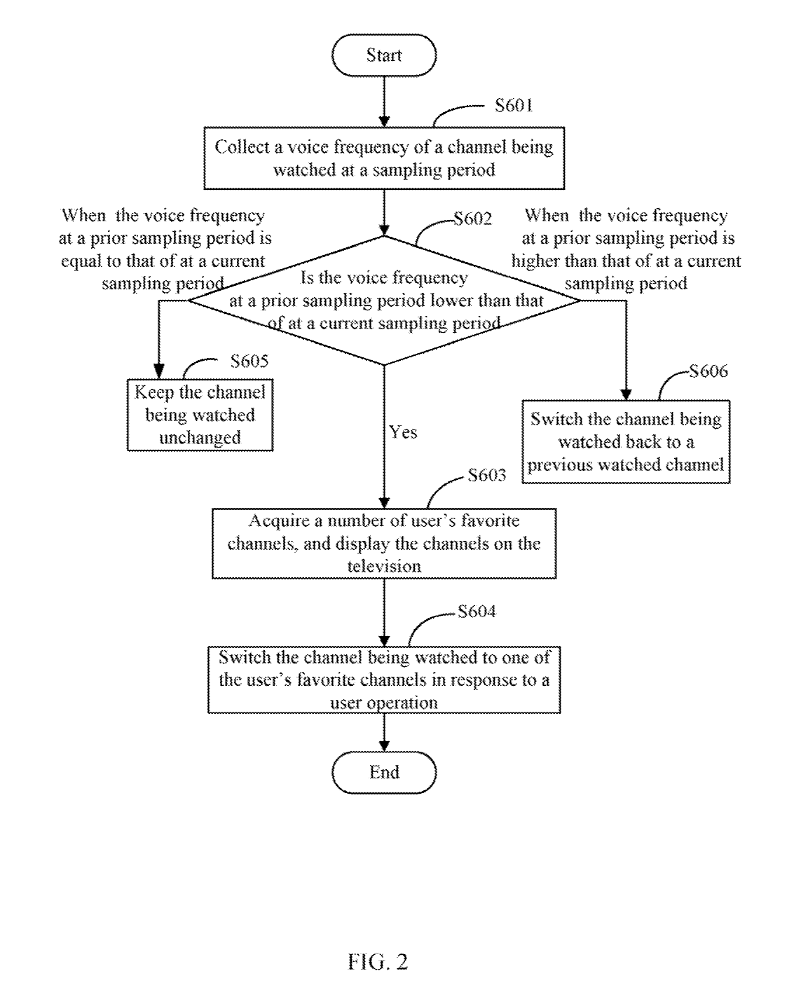

FIG. 2 is a flowchart of a method for switching channels implemented by the system of FIG. 1, in accordance with an exemplary embodiment.

In step S601, the collecting module 21 collects a voice frequency of the watching channel at a sampling period.

In step S602, the comparing module 22 compares whether the voice frequency at a prior sampling period is lower than the voice frequency at a current sampling period, if yes, the procedure goes to step S603, if no, the procedure goes to step S605 when the voice frequency at a prior sampling period is equal to that of at a current sampling period, or to step S606 when the voice frequency at a prior sampling period is higher than that of at a current sampling period.

In step S603, the channel acquiring module 23 acquires the number of user's favorite channels from the storage unit 10, and displays the acquired channels on the TV.

In step S604, the channel switching module 24 switches the watching channel to one of the number of user's favorite channels in response to the user operation.

In step S605, the channel switching module 24 keeps the watching channel unchanged.

In step S606, the channel switching module 24 switches the watching channel back to the previous watching channel.

In one embodiment, the method further includes steps as follows: the collecting module 21 collects volume value of the watching channel at a sampling period, the comparing module 22 compares the volume value at a prior sampling period with the volume value at a current sampling period, the channel acquiring module 23 acquires the number of user's favorite channels from the storage unit 10 when the voice frequency at the prior sampling period is lower than the voice frequency at the current sampling period and the volume value at the prior sampling period is less than the volume value at the current sampling period, and the channel switching module 24 switches the watching channel to one of the user's favorite channels in response to the user operation.

In one embodiment, the method further includes steps as follows: the channel switching module 24 switches the channel to the previous watching channel when the voice frequency at the prior sampling period is higher than the voice frequency at the current sampling period and the volume value at the prior sampling period is more than the volume value at the current sampling period.

Although the present disclosure has been specifically described on the basis of the embodiments thereof, the disclosure is not to be construed as being limited thereto. Various changes or modifications may be made to the embodiments without departing from the scope and spirit of the disclosure.

1. A system with a function of switching channels of a television (TV), the system comprising:
a processing unit;
a plurality of modules to be executed by the processing unit, wherein the plurality of modules comprise:
a collecting module configured to collect a voice frequency of a watching channel at a sampling period;
a comparing module configured to compare the voice frequency at a prior sampling period with the voice frequency at a current sampling period; and
a channel switching module configured to switch the watching channel to another channel when the voice frequency at the prior sampling period is lower than the voice frequency at the current sampling period.

2. The system as described in claim 1, wherein the channel switching module is further configured to switch another channel back to the previous watching channel when the voice frequency at the prior sampling period is higher than the voice frequency at the current sampling period.

3. The system as describe in claim 1, wherein the channel switching module is further configured to keep the watching channel unchanged when the voice frequency at the prior sampling period is equal to the voice frequency at the current sampling period.

4. The system as described in claim 1, wherein another channel switched from the watching channel is a predetermined channel or a random channel.

5. The system as described in claim 1, wherein the collect module is further configured to collect a volume value of the watching channel at a sampling period, the comparing module is further configured to compare the volume value at a prior sampling period with the volume value at a current sampling period, and the channel switching module is further configured to switch the watching channel to another channel when the voice frequency at the prior sampling period is lower than the voice frequency at the current sampling period and the volume value at the prior sampling period is less than the volume value at the current sampling period.

6. The system as described in claim 5, wherein the channel switching module is further configured to switch another channel to the previous watching channel when the voice frequency at the prior sampling period is higher than the voice frequency at the current sampling period and the volume value at the prior sampling period is more than the volume value at the current sampling period.

7. A system with a function of switching channels of a television (TV), the system comprising:
a storage unit configured to store a plurality of user's favorite channels;
a processing unit; and
a plurality of modules to be executed by the processing unit, wherein the plurality of modules comprise:
a collecting module configured to collect a voice frequency of a watching channel at a sampling period;
a comparing module configured to compare the voice frequency at a prior sampling period with the voice frequency at a current sampling period; and
a channel acquiring module configured to acquire the plurality of user's favorite channels from the storage unit, and display the acquired user's favorite channels on the TV when the voice frequency at the prior sampling period is lower than the voice frequency at the current sampling period; and
a channel switching module configured to switch the watching channel to one of the acquired plurality of user's favorite channels in response to a user operation.

8. The system as described in claim 7, wherein the channel switching module is further configured to switch the user's favorite channel back to the previous watching channel when the voice frequency at the prior sampling period is higher than the voice frequency at the current sampling period.

9. The system as described in claim 7, wherein the channel switching module is further configured to keep the watching channel unchanged when the voice frequency at the prior sampling period is equal to the voice frequency at the current sampling period.

10. The system as described in claim 7, wherein the collect module is further configured to collect a volume value of the watching channel at a sampling period, the comparing module is further configured to compare the volume value at a prior sampling period with the volume value at a current sampling period, the channel acquiring module is further configured to acquire the plurality of user's favorite channels from the storage unit, and display the acquired favorite channels on the TV when the voice frequency at the prior sampling period is lower than the voice frequency at the current sampling period and the volume value at the prior sampling period is less than the volume value at the current sampling period, and the channel switching module is further configured to switch the watching channel to one of the acquired plurality of user's favorite channels in response to a user operation.

11. The system as described in claim 10, wherein the channel switching module is further configured to switch the user's favorite channel to the previous watching channel when the voice frequency at the prior sampling period is higher than the voice frequency at the current sampling period and the volume value at the prior sampling period is more than the volume value at the current sampling period.

12. A method for switching channels of a television (TV) implemented by a system which comprises a processing unit to execute a plurality of steps, and a storage unit to store a plurality of user's favorite channels, wherein the plurality of steps comprises:
collecting a voice frequency of a watching channel at a sampling period;
comparing the voice frequency at a prior sampling period with the voice frequency at a current sampling period;
acquiring the plurality of user's favorite channels from the storage unit, and displaying the acquired user's favorite channels on the TV when the voice frequency at the prior sampling period is lower than the voice frequency at the current sampling period; and
switching the watching channel to one of the acquired plurality of user's favorite channels in response to a user operation.

13. The method as described in claim 12, further comprising:
switching the user's favorite channel back to the previous watching channel when the voice frequency at the prior sampling period is higher than the voice frequency at the current sampling period.

14. The method as described in claim 12, further comprising:
keeping the watching channel unchanged when the voice frequency at the prior sampling period is equal to the voice frequency at the current sampling period.

15. The method as described in claim 12, further comprising:
collecting a volume value of the watching channel at a sampling period;
comparing the volume value at a prior sampling period with the volume value at a current sampling period;
acquiring the plurality of user's favorite channels from the storage unit, and displaying the acquired favorite channels on the TV when the voice frequency at the prior sampling period is lower than the voice frequency at the current sampling period and the volume value at the prior sampling period is less than the volume value at the current sampling period; and
switching the watching channel to one of the acquired plurality of user's favorite channels in response to a user operation.

16. The method as described in claim 15, further comprising:
switching the user's favorite channel to the previous watching channel when the voice frequency at the prior sampling period is higher than the voice frequency at the current sampling period and the volume value at the prior sampling period is more than the volume value at the current sampling period.
